(19) United States
(12) Patent Application Publication
(10) Pub. No.: US 2005/0225054 A1
(43) Pub. Date: Oct. 13, 2005

(54) Compact integral lock for receiver tube type towing accessories

(76) Inventor: Paul William Budge, Washington, UT (US)

Correspondence Address: Paul W. B udge, P.O. Box 910758, St. George, UT, 84791, US

(21) Appl. No.: 10/978,161

(22) Filed: Oct. 30, 2004

Related U.S. Application Data
(60) Provisional application No. 60/560,377, filed on Apr. 8, 2004.

(51) Int. Cl. B60D 1/28

(52) U.S. Cl. 280/507

(57) ABSTRACT

A compact integral locking means for receiver tube coupled type towing accessories such as fixed drop ball mounts, adjustable height ball mounts, towing bars, bicycle racks, cargo boxes, and many other receiver tube type towing accessories. The current invention provides a integral locking means for lockingly engaging or coupling a towing accessory within a receiver tube that is attached to a tow vehicle. The integral locking means comprises a slide pin, a slide pin actuation means, and a slide pin actuation control means or mechanism. The slide pin actuator control means controls the slide pin actuator means. the slide pin actuator means moves one or more slide pins from a locked or receiver tube coupled position to a unlocked or uncoupled position. When the integral key lock equipped towing accessory is locked or coupled to the receiver it can only be removed with the appropriate key and if equipped with a button or lever verses a keyed lock cylinder then the button or lever is used to engage or disengage the towing accessory from the receiver tube of the tow vehicle. Providing a towing accessory with a compact integral locking mechanism better deters the tampering with and or theft of the towing accessory and or attached trailer. In the preferred key lock embodiment of the invention, the towing accessory can only be inserted into the receiver tube when the key is in the lock cylinder and it is positioned in the unlocked position, the key can only be removed once the accessory has been successively coupled with the receiver tube and the key is in the locked or coupled key position.

### CROSS-REFERENCE TO RELATED APPLICATIONS

This application claims benefit of U.S. Provisional Application No. 60/560,377 filed on Apr. 8, 2004

### BACKGROUND OF THE INVENTION

1. Field of the Invention

This invention relates to a locking device for hitches or receiver tube inserted and coupled towing accessories such towing ball mounts.

2. Description of Related Art

Several patents exist concerning locking devices for receiver hitches. These include those described in U.S. Pat. No. 6,543,260, U.S. Pat. No. 6,412,315 and U.S. Pat. No. 5,540,065. All known prior art devices and the above mentioned patents utilize a locking device connected to some kind of hitch pin or shaft. The locking device is usually attached at on end or the other and generally the have a bend or enlarged head at the other end. These devices work in primarily the same fashion as a typical hitch pin and clip only the clip has been replaced by a locking device.

Hitch pins and locking hitch pins have been used for many years and in most cases do a very good job of providing a solid coupling connection between the receiver tube and the ball mount or other accessory being used. One draw back to connection system is it usually requires two to three parts to complete the coupling process. This increase the chance of misplacing some of the needed components to complete the connection. Another disadvantage is the chains and electrical connection generally obstruct the hitch pin receiving holes, therefor, hampering a relatively simple connection. And still another potential problem with having a externally clipped or locked device is they become easy targets for thieves as the external clip or lock can be tampered with or easily cut off.

Integral locking device of the current invention overcomes these disadvantages while still providing an incredibly strong towing connection.

### SUMMARY OF THE INVENTION

The present invention is compact integral locking means or device for receiver tube coupled type towing accessories such as fixed drop ball mounts, adjustable height ball mounts, towing bars, bicycle racks, cargo boxes, and many other receiver tube type towing accessories.

The present invention provides a integral locking means for lockingly engaging or coupling a towing accessory within a receiver tube that is attached to a tow vehicle. This integral locking means comprises a slide pin, a slide pin actuation means, and a slide pin actuation control means or mechanism. The slide pin actuator control means controls the slide pin actuator means. the slide pin actuator means moves one or more slide pins from a locked or receiver tube coupled position to a unlocked or uncoupled position.

A towing accessory equipped with the preferred embodiment of the present invention if locked or coupled to the receiver can only be removed with the appropriate key and if equipped with a button or lever verses a keyed lock cylinder then the button or lever is used to engage or disengage the towing accessory from the receiver tube of the tow vehicle.

Providing a towing accessory with a compact integral locking mechanism better deters the tampering with and or theft of the towing accessory and or attached trailer.

In the preferred key lock embodiment of the invention, the towing accessory can only be inserted into the receiver tube when the key is in the lock cylinder and it is positioned in the unlocked position. The key can only be removed once the accessory has been successively coupled with the receiver tube and the key is in the locked or coupled key position.

The present invention can be incorporated within most solid body towing accessories by simply machining one or two additional holes in the accessory component. This lock can be incorporated into hollow tube type components in a similar fashion. The preferred embodiment is to utilize a supporting member or round pipe for the slide pins or as shown in the FIG. 5 drawing simply insert a standardized modular component that has the integral locking device housed within the module through the hollow tube. This module can then be installed with ease and without making any major modifications to a existing towing component that might benefit from a more appealing integral locking means.

### BRIEF DESCRIPTION OF THE DRAWINGS

FIG. 1 is a perspective view of solid construction towing accessory.

FIG. 2 is side view of a solid construction towing accessory utilizing the compact integral locking components of the preferred embodiment.

FIG. 3 is a cross-sectional top view of the preferred embodiment integral lock within a towing receiver tube and in the unlocked position.

FIG. 4 is a cross-sectional top view of the preferred embodiment integral lock within a towing receiver tube and in the locked position.

FIG. 5 is a perspective view of a hollow tube towing accessory with the preferred hollow tube embodiment of the invention. Shown at the top of the drawing is the standardized modular housing with the integral locking components shown within and in the locked position.

FIG. 6 is cross sectional view of the modular housing unit with preferred embodiment integral locking components in the unlocked position. The slide pin actuator control means is shown in a parallel orientation with relation to the slide pins and a radial orientation is shown in phantom.

FIG. 7 is cross sectional view of the modular housing unit with preferred embodiment integral locking components in the locked position. The slide pin actuator control means is shown in a parallel orientation with relation to the slide pins and a radial orientation is shown in phantom.

FIG. 8 is top view of the oversized overlapping preferred embodiment style slide pins. Actuation engaging surfaces of the preferred embodiment are shown in phantom lines.

FIG. 9 is a front view of the oversized overlapping preferred embodiment style slide pins. A mechanical type actuation means is shown going through the center of the slide pins.

### DETAILED DESCRIPTION OF THE INVENTION

The compact integral lock of the present invention comprises a slide pin 2, a slide pin actuation means 1 and a slide pin actuator control means 3,8 these components can be utilized in a solid construction towing accessory 4 or in a hollow tube type towing accessory 6 with or without the use a modular housing 7 or other supporting members.

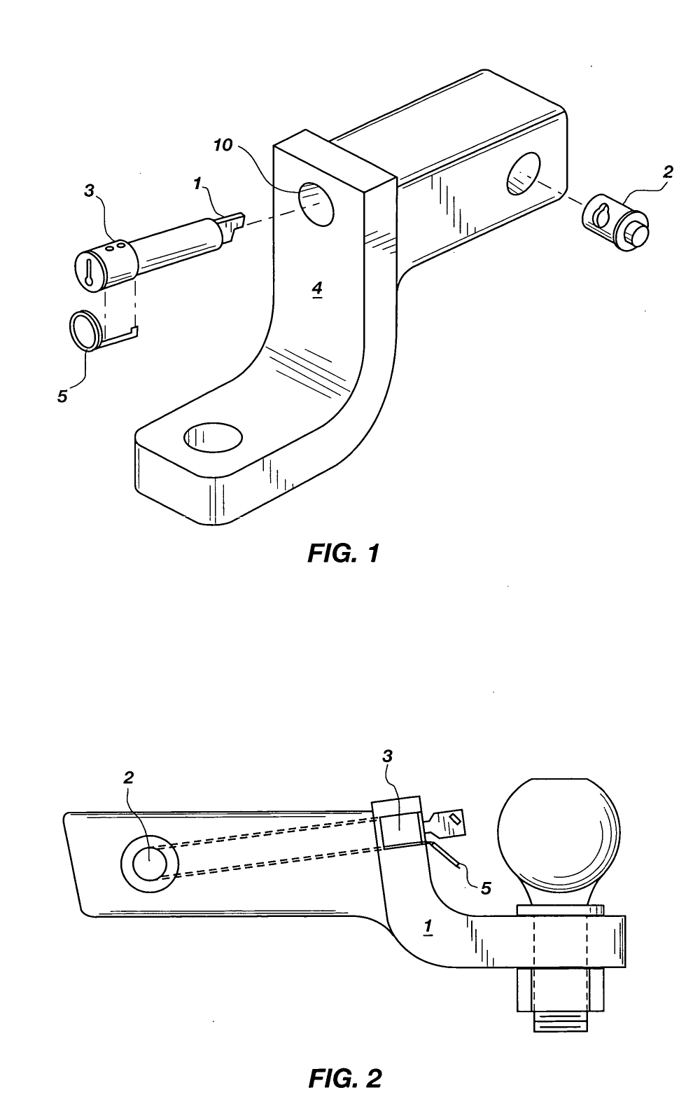

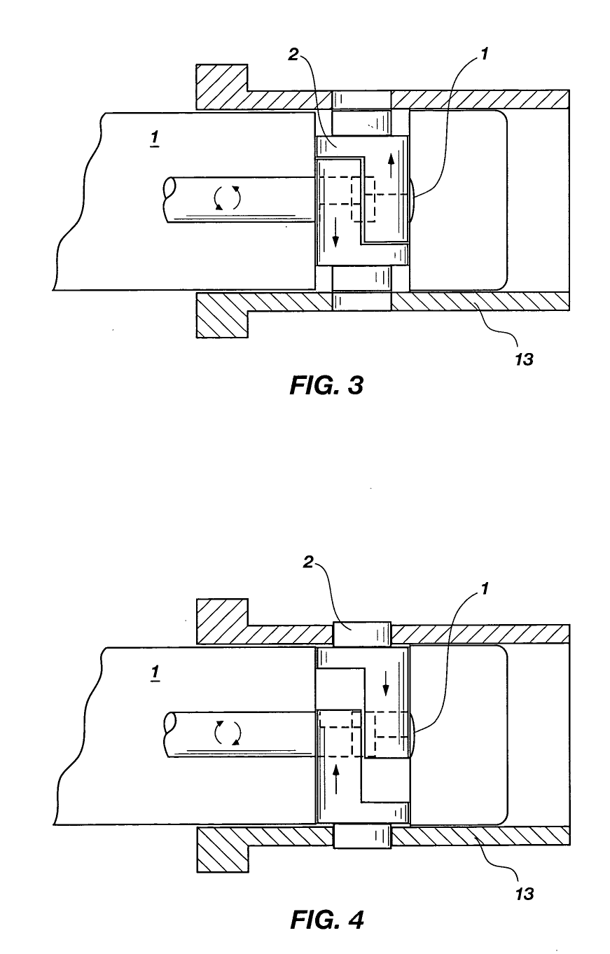

A solid construction towing accessory as shown in FIG. 1 can be machined to except at least one or as preferred two slide pins 2 as shown in FIGS. 1,2,3,4,5,6,7,8 and 9 as in the shown preferred style and configuration as oversized and overlapping slide pins with a though cam surface bore and o-ring grooves 12 and at least one slide pin actuation means 1 as shown in the preferred embodiment as a mechanical dual offset lobe cam shaft used to engage and move the slide pins 2 from a receiver tube 13 locked position as shown in FIG. 4 to a unlocked and removable from the receiver tube 13 position as shown in FIG. 3. A slide pin actuator control means 3,8 as shown in the preferred embodiment of FIGS. 1,2,5,6 and 7 as a radial oriented keyed lock cylinder 3 and as a parallel oriented lock cylinder in 8 is used to control the actuation means. A cover 5 may also be attached to the slide pin actuator control 3,8 or to the towing accessory 4,6 body to keep dust and moisture out of the components.

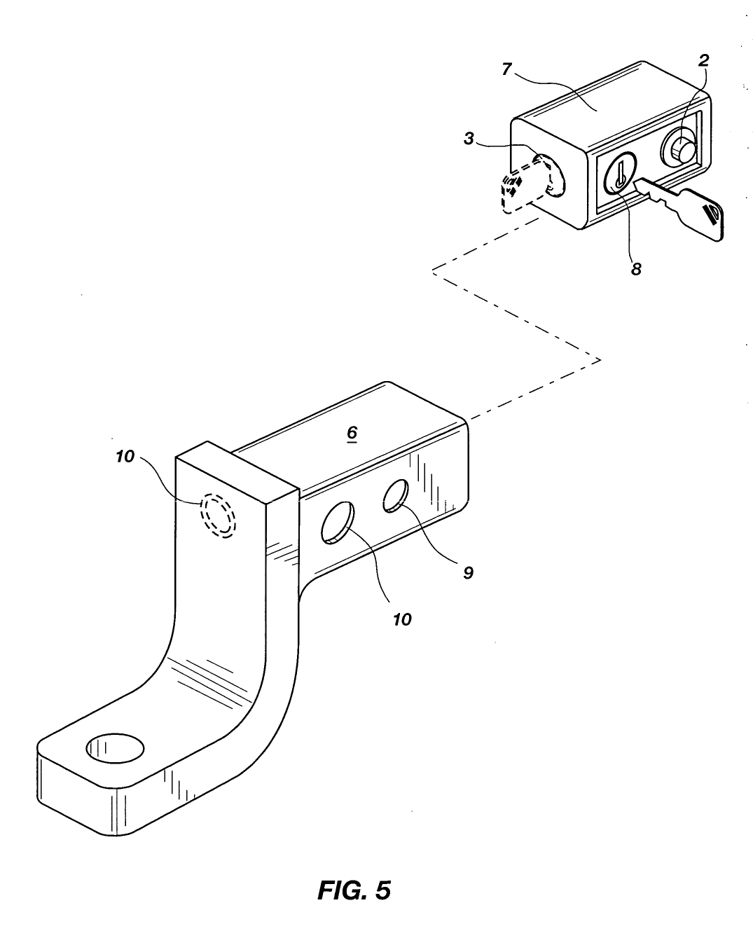

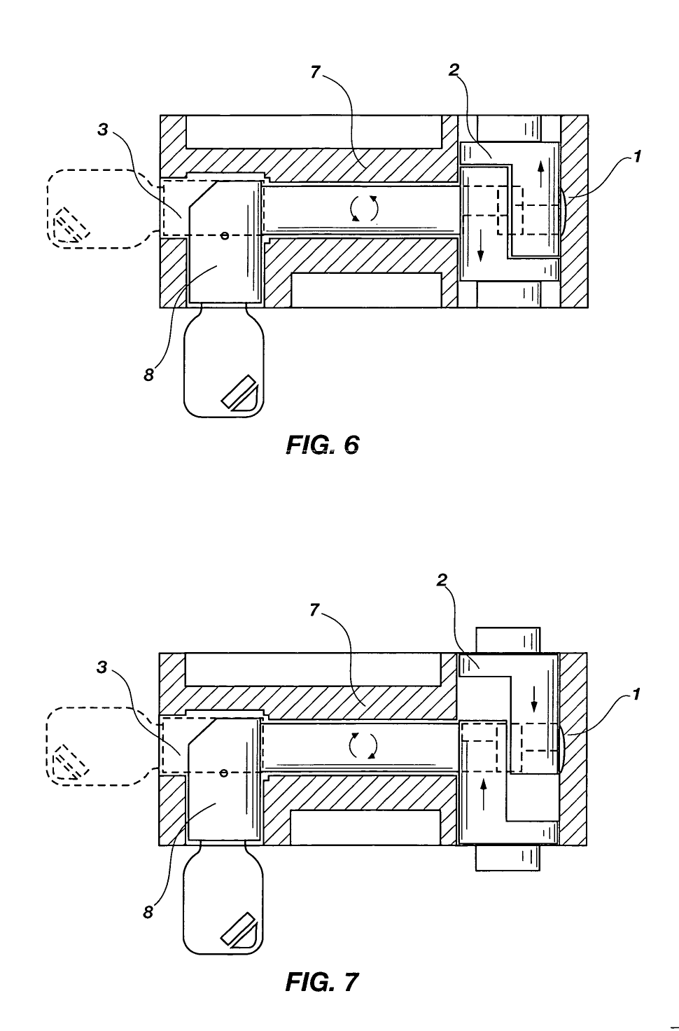

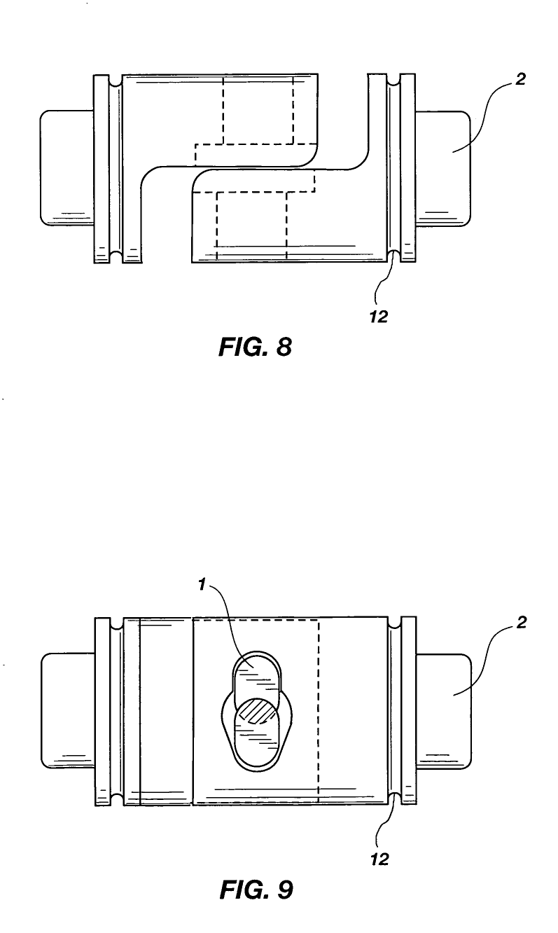

As shown in FIG. 5 the present invention may easily be installed or incorporated within a standardized module 7 in the same fashion as the components would be placed in a solid construction towing accessory 4 before or after the module 7 or other support members such as a round tube have been inserted in the hollow tube towing accessory 6. FIG. 5 also shows bore 9 as the slide pin 2 though passage bore and bore 10 shows the slide pin actuator control means 8 parallel through bore and the phantom bore 10 shows a alternative radial oriented though bore for the slide pin actuator control means 3.

As used herein, the term “preferred” means that a specified element or technique is more acceptable than another but not that such specified element or technique is a necessity.

The invention has been described with reference to the preferred embodiment. Obviously, modifications and alterations will occur to others upon a reading and understanding of this specification. The claims as follows are intended to include all modifications and alterations insofar as they come within the scope of the claims or the equivalents thereof.

1. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a slide pin actuator control means being at least one of: (i) a keyed lock cylinder (ii) a push pull button (iii) a switch (iv) a lever (v) a knob (vi) a touch pad (vii) a pin (vii) a clip. (viii) a manual control.

2. The compact integral lock of claim 1 wherein said compact integral lock includes at least one said side pin wherein said slide pin is movable between a locked position wherein said slide pin lockingly engages said receiver tube of a tow vehicle thereby preventing removal of said receiver tube coupled type towing accessory from said receiver tube of a tow vehicle and a unlocked position wherein said slide pin does not engage said receiver tube of a tow vehicle thereby permitting removal of said receiver tube coupled type towing accessory from said receiver tube of a tow vehicle.

3. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a slide pin actuator control means being at least one of: (i) a keyed lock cylinder (ii) a push pull button (iii) a switch (iv) a lever (v) a knob (vi) a touch pad (vii) a pin (vii) a clip (viii) a manual control.

4. The compact integral lock of claim 3 wherein said compact integral lock comprises at least one said slide pin actuation means.

5. The device of claim 4 wherein said slide pin actuation means moves said slide pin between a locked and unlocked position.

6. The device of claim 4 wherein said slide pin actuation means has at least one of: (i) a axial orientation with said slide pin (ii) a radial orientation with said slide pin (iii) a angular orientation with said slide pin (iv) a parallel orientation with said slide pin.

7. The compact integral lock of claim 3 wherein said compact integral lock comprises at least one said slide pin actuator control means.

8. The devise of claim 7 wherein said slide pin actuator control means controls the said slide pin actuation means.

9. The device of claim 7 wherein said slide pin actuator control means has at least one of: (i) a axial orientation with said slide pin (ii) a radial orientation with said slide pin (iii) a angular orientation with said slide pin (iv) a parallel orientation with said slide pin.

10. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a slide pin actuator control means being at least one of: (i) a keyed lock cylinder (ii) a push pull button (iii) a switch (iv) a lever (v) a knob (vi) a touch pad (vii) a pin (vii) a clip (viii) a manual control.

11. The compact integral lock of claim 10 wherein said compact integral lock is at least one of: (i) a integral component of said receiver tube coupled type towing accessory (ii) a insert module of said receiver tube coupled type towing accessory.

12. The device of claim 11, wherein said insert module comprises a housing for supporting said integral lock.

13. The compact integral lock of claim 10 wherein said slide pin may be lockingly engaged within said receiver tube of a tow vehicle at one or more discrete positions within said receiver tube of a tow vehicle so that said receiver tube coupled type towing accessory may accommodate an additionally attached accessory item that may be coupled to said receiver tube type coupled towing accessory prior to being coupled with said receiver tube of a tow vehicle.

14. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a keyed lock cylinder control means being at least one of: (i) a random key coded lock cylinder (ii) a keyed alike lock cylinder.

15. The compact integral lock of claim 14 wherein said compact integral lock includes at least one said side pin wherein said slide pin is movable between a locked position wherein said slide pin lockingly engages said receiver tube of a tow vehicle thereby preventing removal of said receiver tube coupled type towing accessory from said receiver tube of a tow vehicle and a unlocked position wherein said slide pin does not engage said receiver tube of a tow vehicle thereby permitting removal of said receiver tube coupled type towing accessory from said receiver tube of a tow vehicle.

16. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a keyed lock cylinder control means being at least one of: (i) a random key coded lock cylinder (ii) a keyed alike lock cylinder.

17. The compact integral lock of claim 16 wherein said compact integral lock comprises at least one said slide pin actuation means.

18. The device of claim 16 wherein said slide pin actuation means moves said slide pin between a locked and unlocked position.

19. The device of claim 18 wherein said slide pin actuation means has at least one of: (i) a axial orientation with said slide pin (ii) a radial orientation with said slide pin (iii) a angular orientation with said slide pin (iv) a parallel orientation with said slide pin.

20. The compact integral lock of claim 16 wherein said compact integral lock comprises at least one said keyed lock cylinder control means.

21. The devise of claim 20 wherein said keyed lock cylinder control means controls the said slide pin actuation means.

22. The device of claim 20 wherein said keyed lock cylinder control means has at least one of: (i) a axial orientation with said slide pin (ii) a radial orientation with said slide pin (iii) a angular orientation with said slide pin (iv) a parallel orientation with said slide pin.

23. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a keyed lock cylinder control means being at least one of: (i) a random key coded lock cylinder (ii) a keyed alike lock cylinder.

24. The compact integral lock of claim 23 wherein said compact integral lock is at least one of: (i) a integral component of said receiver tube coupled type towing accessory (ii) a insert module of said receiver tube coupled type towing accessory.

25. The device of claim 24, wherein said insert module comprises a housing for supporting said integral lock.

26. The compact integral lock of claim 23 wherein said slide pin may be lockingly engaged within said receiver tube of a tow vehicle at one or more discrete positions within said receiver tube of a tow vehicle so that said receiver tube coupled type towing accessory may accommodate an additionally attached accessory item that may be coupled to said receiver tube type coupled towing accessory prior to being coupled with said receiver tube of a tow vehicle.

27. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a keyed lock cylinder control means being at least one of: (i) a random key coded lock cylinder (ii) a keyed alike lock cylinder.

28. The compact integral lock of claim 27 wherein said keyed lock cylinder control means comprises a lock cylinder with only one key release position for only allowing the key to be removed in the locked position.

29. A compact integral lock for receiver tube coupled type towing accessories, said integral lock comprises:
a slide pin wherein at least a portion thereof lockingly engages the receiver tube of a tow vehicle; and
a slide pin actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a slide pin actuator control means being at least one of: (i) a keyed lock cylinder (ii) a push pull button (iii) a switch (iv) a lever (v) a knob (vi) a touch pad (vii) a pin (vii) a clip (viii) a manual control.

30. The compact integral lock of claim 29 wherein said compact integral lock comprises at least one said slide pin.

31. The device of claim 30 wherein said slide pin utilizes at least one of: (i) a o-ring (ii) a flat annular seal (iii) a press in seal

32. A compact integral lock for receiver tube coupled type towing accessories, said integral lock comprises:
a ball wherein at least a portion thereof lockingly engages the receiver tube of a tow vehicle; and
a ball actuation means being at least one of: (i) a mechanical actuator (ii) a hydraulic actuator (iii) a pneumatic actuator (iv) a electric actuator (v) a magnetic actuator (vi) a spring actuator (vii) a manual actuation.
a ball actuator control means being at least one of: (i) a keyed lock cylinder (ii) a push pull button (iii) a switch (iv) a lever (v) a knob (vi) a touch pad (vii) a pin (vii) a clip. (viii) a manual control.

33. The compact integral lock of claim 32 wherein said compact integral lock includes at least one ball wherein said ball is movable between a locked position wherein said ball lockingly engages said receiver tube of a tow vehicle thereby preventing removal of said receiver tube coupled type towing accessory from said receiver tube of a tow vehicle and a unlocked position wherein said ball does not engage said receiver tube of a tow vehicle thereby permitting removal of said receiver tube coupled type towing accessory from said receiver tube of a tow vehicle.

34. A compact integral lock for securing said receiver tube type coupled towing accessory to said receiver tube of a tow vehicle comprising the steps of:
providing a ball;
providing a ball actuation means;
providing a ball actuation control means;
inserting a portion of said compact integral lock equipped said receiver tube coupled type towing accessory within said receiver tube of a tow vehicle and then by using said ball actuation control means to control said ball actuation means to move said ball to engage and lock said receiver tube coupled type towing accessory to said receiver tube of a tow vehicle thereby preventing removal of said receiver tube coupled type towing accessory from said receiver tube of a tow vehicle.

35. A compact integral lock for securing said receiver tube type coupled towing accessory to said receiver tube of a tow vehicle comprising the steps of:
providing a slide pin;
providing a slide pin actuation means;
providing a slide pin actuation control means;
inserting a portion of said compact integral lock equipped said receiver tube coupled type
towing accessory within said receiver tube of a tow vehicle and then by using said slide pin actuation control means to control said slide pin actuation means to move said slide pin to engage and lock said receiver tube coupled type towing accessory to said receiver tube of a tow vehicle thereby preventing removal of said receiver tube coupled type towing accessory from said receiver tube of a tow vehicle.
